(19) United States
(12) Patent Application Publication
(10) Pub. No.: US 2001/0038328 A1
(43) Pub. Date: Nov. 8, 2001

(54) Multifunction and multiple range RKE system and method

(76) Inventors: Ronald O. King, Brownstown, MI (US); Qingfeng Tang, Novi, MI (US); John Nantz, Brighton, MI (US); Douglas C. Campbell, Northville, MI (US); Riad Ghabra, Dearborn Heights, MI (US)

Correspondence Address: Ralph E. Smith, Brooks & Kushman P.C., 1000 Town Center, 22nd Floor, Southfield, MI, 48075-1351, US

(21) Appl. No.: 09/826,335

(22) Filed: Apr. 4, 2001

Related U.S. Application Data
(60) Provisional application No. 60/194,656, filed on Apr. 4, 2000.

(51) Int. Cl. G06F 7/04

(52) U.S. Cl. 340/5.64; 340/825.69; 455/134; 455/226.2

(57) ABSTRACT

A multifunction remote keyless entry system is provided that increases functionality of the transmitter without increasing the size of the transmitter unit by having certain buttons on the transmitter perform multiple functions based on the distance from the vehicle. More specifically, actuation of a button on the portable transmitter unit triggers operation of a first designated function if the transmitter is outside a predetermined range from the vehicle. Actuation of the same button within the predetermined range will trigger operation of a second designated function. Thus, one button performs at least two functions depending on the distance the user is from the vehicle. In a further embodiment, the same button could trigger operation of a set of different functions as a function of multiple, concentric zones around the vehicle.

CROSS-REFERENCE TO RELATED APPLICATIONS

This application claims the benefit of U.S. provisional application Serial No. 60/194,656 filed Apr. 4, 2000.

### BACKGROUND OF THE INVENTION

1. Field of the Invention

The present invention relates to remote keyless entry (RKE) systems used with vehicles, and more particularly, to improvements that allow certain system functions to be controlled as a function of the distance between a vehicle and the RKE transmitter unit.

2. Background Art

Generally, it is desirable to increase the number of possible devices that can be controlled by a RKE transmitter so as to increase overall convenience and security to a vehicle operator. In other words, increasing the number of functions that can be controlled by a transmitter used in an RKE application is becoming increasingly important as technology advances. However, it is also desirable to maintain or reduce the overall size of an RKE transmitter device. Thus, a need exists for a way of increasing functionality of the transmitter without increasing the size of the transmitter unit.

In addition, as technology advances, the range of RKE systems for vehicles has extended to 50 meters or more. With such an extended range, inadvertent actuations of the RKE system at 50 meters could happen without the knowledge of the user. Therefore, a need also exists for an RKE system that can reduce the likelihood of such inadvertent system actuation.

### SUMMARY OF THE INVENTION

The present invention addresses the above-noted need by providing a multifunction wireless remote control system and method that increases functionality of the transmitter without increasing the size of the transmitter unit by having buttons on a portable transmitter unit that trigger operation of different functions based on the distance from the vehicle at the time of actuation of the button.

In accordance with one aspect of the present invention, a wireless remote control system is provided having a wireless transmitter including a button arranged to cause the transmitter to transmit a command signal upon actuation by a user, and a receiver for receiving the transmitted command signal. A signal detector is connected to the receiver for detecting the distance of the transmitter from the receiver as a function of the signal strength of the received signal. A controller is responsive to the signal detector for performing a first associated function if the transmitter is detected as being within a predetermined range, and a different function if the transmitter is detected as being outside the predetermined range.

In accordance with other features of the present invention, the wireless remote control system can be a remote keyless entry system for a vehicle where the receiver is mounted to the vehicle. The receiver is arranged to generate an output signal that is proportional to the signal strength of the received command signal. The signal detector can be arranged to compare the signal strength of the received command signal to a predetermined threshold value indicative of distance from the receiver. In addition, the signal detector can be arranged to compare the signal strength of the received command signal to a plurality of different predetermined threshold values, each indicative of different distance from the receiver, and the controller can be arranged to perform a different operation as a function of each distance threshold.

In accordance with another aspect of the present invention, a signal processor can be connected to the receiver for determining whether the received command signal is one of a set of commands enabled only for short-range operation. The controller is responsive to the signal processor for performing the function associated with a short-range enabled command signal if the transmitter is detected as being within the predetermined range. The transmitter can be arranged to create a reduced signal strength for any command signal limited to shorter range operation.

In accordance with another aspect of the present invention, a method of remotely controlling operation of at least two different functions in a wireless remote control system having a transmitter and a receiver, the method including transmitting a command signal, receiving the command signal, and detecting the distance of the transmitter from the receiver as a function of the signal strength of the received signal. A first function is performed if the transmitter is detected as being within a predetermined range, and a different function is performed if the transmitter is detected as being outside the predetermined range.

Thus, the present invention provides increased functionality of a transmitter such as used in an RKE system without increasing the size of the transmitter unit. This is accomplished by arranging a button on the transmitter to automatically control different functions based on a detected distance from the vehicle. As a result, actuation of a button on the transmitter unit triggers operation of a first designated function if the transmitter is outside a predetermined range from a receiver, while actuation of the same button within the predetermined range will trigger operation of a second designated function. In addition, the same button can be arranged to automatically trigger operation of a different function for each one of a set of concentric designated zones extending around a vehicle or object to be controlled.

These and other objects, features, and advantages of the present invention will be readily apparent from the following detailed description of the best mode for carrying out the invention when taken in connection with the accompanying drawings.

### BRIEF DESCRIPTION OF THE DRAWINGS

FIG. 1 is a block diagram of an exemplary wireless remote control system in accordance with the present invention;

FIG. 2 is a flow chart showing overall controller operation in accordance with the present invention;

FIG. 3 is an aerial representation of the different ranges for associated system functions in accordance with the present invention;

FIG. 4 is a flow chart showing controller operation in accordance with an exemplary embodiment of the present invention;

FIG. 5 is a flow chart showing controller operation in accordance with an exemplary embodiment of the present invention having lockout of certain system functions; and

FIG. 6 is an aerial representation of the different ranges for the embodiment of FIG. 5.

### DETAILED DESCRIPTION OF THE PREFERRED EMBODIMENT(S)

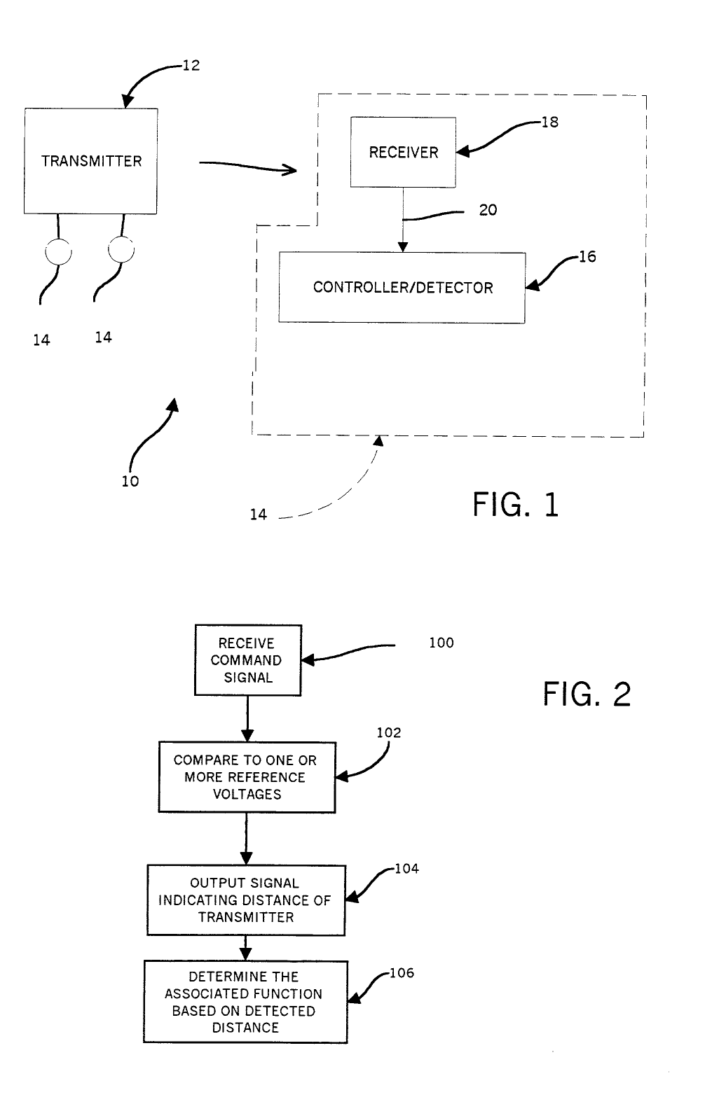

One example of the present invention is its use in a remote keyless entry (RKE) system used to remotely control various functions on a vehicle such door and trunk locking and unlocking. As shown in FIG. 1, a portable transmitter 10 such as in the form of a fob communicates with a receiver/control module 12 located on a vehicle. The transmitter includes suitable processing/encoding circuitry, such as a microprocessor-based circuit arrangement, to generate a set of command signals that trigger operation of a certain task, such as locking or unlocking the doors, releasing the trunk, or operating vehicle lights, horn and/or other vehicle alarm system. The command signals are sent upon actuation of an associated one of a plurality of buttons 14 on transmitter 10. These buttons may be tactile or touch-type switches, and can be coupled to the control circuit. The signals are preferably transmitted using an RF type transmitter. The command signals can be encrypted in accordance with known encryption techniques.

In a preferred embodiment, the control module includes a control circuit, such as a microprocessor-based circuit 16, coupled to a super-heterodyne type receiver 18 capable of producing a Received Signal Strength Indicator (RSSI) output 20. The RSSI output is proportional to the input signal present at a receiver's front end. As the strength of the RF input signal is increased, an increased DC voltage is present at the RSSI output.

Overall operation of a first exemplary embodiment of the present invention will be now be described in connection with the flow chart of FIG. 2. As denoted in blocks 100 and 102, upon receipt of a command signal, a detection circuit or algorithm in the control circuit of the control module compares the DC voltage from the RSSI output 20 with one or more reference voltages. Each reference voltage provides a measure indicative of distance from the receiver/vehicle as a function signal strength. A control signal is output at block 104 indicative of the result of comparison. More specifically, the control signal is provided as an input to the microprocessor or other suitable decision making circuit as an indication that the RF signal has a field strength indicative of a particular range or distance between the transmitter and the receiver. Detection of the range or distance of the received signal is used at block 106 to determine which of a plurality of associated functions are to be actuated in response to receiving the coded signal.

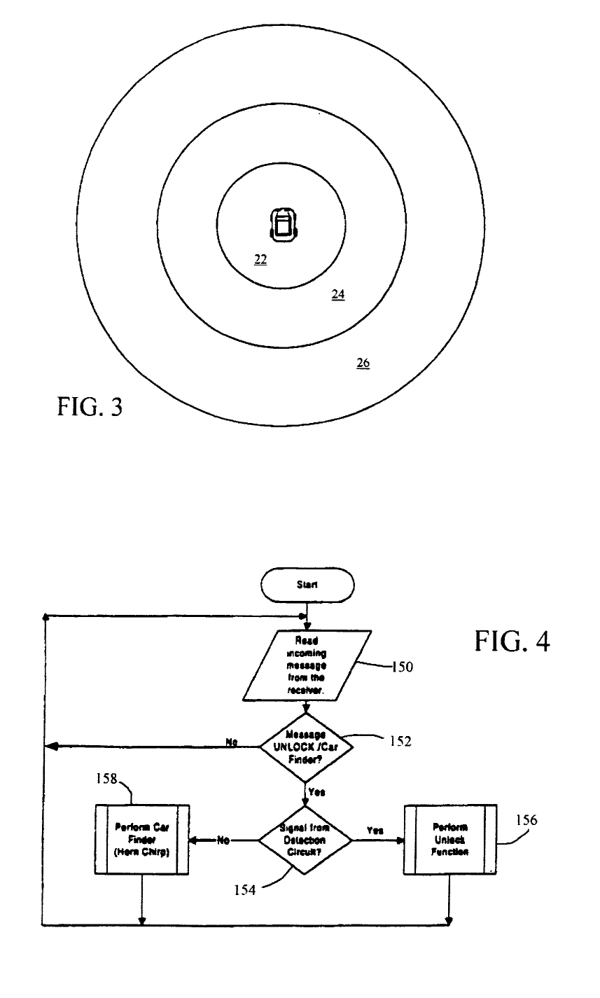

By using this technique, multiple functions can be achieved from a single button on the transmitter. If the user presses a button on the transmitter and is within a predetermined range from the vehicle, the function will be carried out corresponding to the range and actual button pressed. FIG. 3 provides an illustration of different ranges/zones of function based on distance from the vehicle. In a first zone 22 closest to the receiver/vehicle, a first assigned function is operative, while a signal received in a second zone 24 operates to trigger a second assigned function. Likewise for a third outer zone 26 and an associated third assigned function.

FIG. 4 provides a flow chart for an exemplary RKE embodiment. As denoted at block 150, an incoming command signal is read from the receiver. In this example, the received signal could be either an unlock the doors command or a car finder command (i.e., trigger chirping of the vehicle horn). At block 152, a determination is made as to which potential command signal was received by the receiver. In this example, if the received signal was not an unlock/car finder command, the system exits this particular subroutine. However, if the received signal was an unlock/car finder command, the system determines at block 154 whether the range detection circuit produced a positive output signal. As noted above, in a two zone system, the detection circuit or microprocessor determines the distance of the received command signal as a function of received signal strength. If the distance is within a first zone closest to the vehicle, a positive output signal is generated resulting in the unlock function being carried out at block 156. Otherwise, a positive output is not generated and the car finder function is triggered at block 158.

In accordance with another aspect of the present invention, detecting the distance of the transmitted signal can be used to form a dual range system that renders operable certain functions such as door lock, unlock, and trunk opening, only when the transmitter is within a predetermined range from the vehicle. Any other available functions, such as a panic command and car finder, are operable at the full extent of the system range.

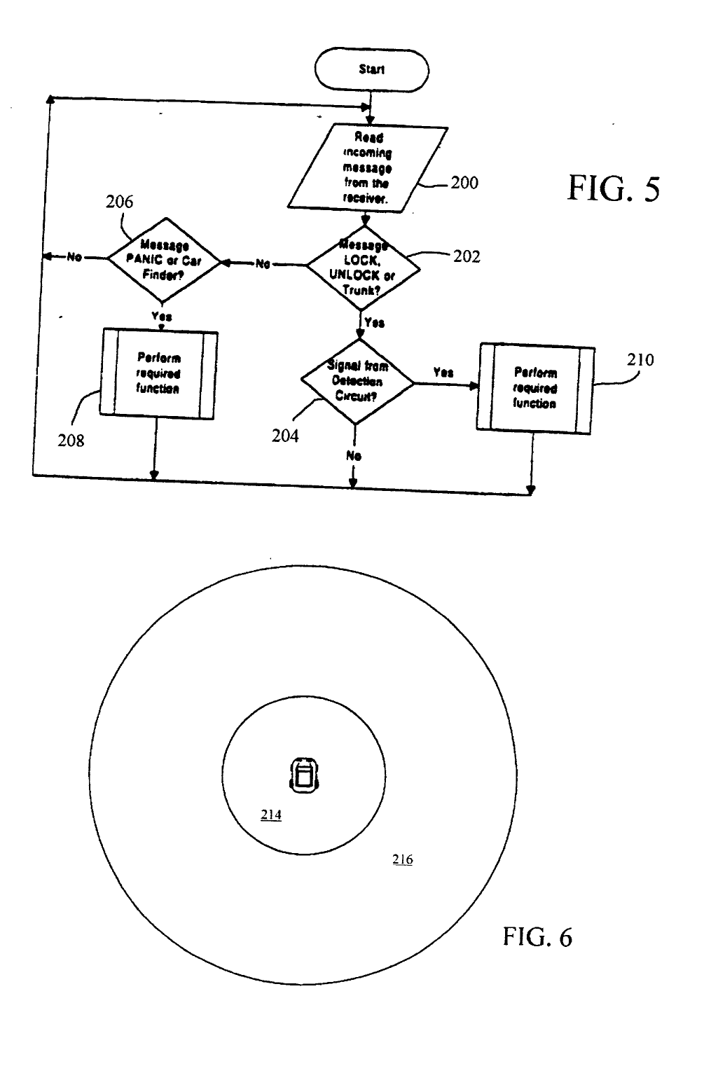

An exemplary embodiment of such a dual range system is shown in FIGS. 5 and 6. More specifically, as denoted at block 200 of FIG. 5, an incoming command signal is read from the receiver. In this example, the received signal could be any one of a lock, unlock, trunk release, panic or a car finder command. At block 202, a determination is made as to which potential command signal was received by the receiver. In this example, if the received signal was a lock, unlock, or trunk release command signal, the system proceeds to block 204. Otherwise, the system proceeds to block 206 and determines whether the received signal is a panic or car finder command. If so, the mere fact that the signal was received operates as a default indication that the signal was transmitted within a maximum system zone 216. Thus, the particular function is immediately performed at block 208. Otherwise, if the signal is not a panic or car finder command, the system returns to the start of this routine.

As denoted at block 204, if the received signal was a lock, unlock or trunk release command, the system determines whether the range detection circuit produced a positive output signal. In other words, if the detected distance is within a first zone 214 closest to the vehicle, a positive output signal is generated resulting in the associated function being performed at block 210. Otherwise, a positive output is not generated and the system returns to the start of the routine.

In wireless systems that send data using FM, the data is transmitted between two different carrier frequencies. The difference in the two frequencies is known as the deviation. Sensitivity of a FM receiver is decreased with a decrease in FM deviation, i.e., the transmitted signal has less energy. The transmitter of the present invention can be arranged to exploit this condition by transmitting data corresponding to a door lock, unlock, and trunk release command at a narrower FM deviation than data transmitted corresponding to a panic or car finder command. The frequency deviation can be reduced enough to allow the lock, unlock, and trunk functions to be operable only within a certain distance from the vehicle. The panic and car finder functions would be transmitted at the optimum frequency deviation for maximum system range.

In systems using ASK, differentiated range can be achieved by sending the data using narrower bit widths for command signals associated with a function for which a shorter range is desired. More specifically, an ASK receiver is normally optimized for a particular bit width for data. Therefore, for long-range functions, a pulse width is used that is optimized for maximum range. For the short-range functions, a narrower pulse width is used such that the receiver will be able to decode the received data only if the transmitter is transmitting from a closer distance. In other words, narrowing the bit width reduces the sensitivity of the receiver, i.e., the strength of the signal.

Thus, a multifunction RKE system is provided that increases functionality of the transmitter without increasing the size of the transmitter unit by having certain buttons on the transmitter perform multiple functions based on the distance from the vehicle. For example, a button such as the unlock button performs a car finder function by causing chirping of a vehicle horn when the user is outside a certain predetermined distance from the vehicle. As the user reaches the predetermined distance, the same signal will cause the doors to unlock. Using this method, one button performs at least two functions depending on the distance the user is from the vehicle. Using this same method, one button could perform multiple functions at different designated zones around the vehicle.

While the present invention has been described particularly in context with a vehicle RKE system, it will be understood that the present invention is equally application any wireless remote control arrangement. Thus, while embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A wireless remote control system comprising:
a wireless transmitter having a button arranged to cause the transmitter to transmit a command signal upon actuation by a user;
a receiver for receiving the transmitted command signal;
a signal detector connected to the receiver for detecting the distance of the transmitter from the receiver as a function of the signal strength of the received signal; and
a controller responsive to the signal detector for performing a first associated function if the transmitter is detected as being within a predetermined range, and a different function if the transmitter is detected as being outside the predetermined range.

2. The system of claim 1 wherein the wireless remote control system comprises a remote keyless entry system for a vehicle, said receiver being mounted to the vehicle.

3. The system of claim 1 wherein the receiver is arranged to generate an output signal that is proportional to the signal strength of the received command signal.

4. The system of claim 1 wherein the receiver comprises a superheterodyne receiver arranged to produce a Received Signal Strength Indicator (RSSI) output.

5. The system of claim 1 wherein the signal detector is arranged to compare the signal strength of the received command signal to a predetermined threshold value indicative of distance from the receiver.

6. The system of claim 5 wherein the signal detector is arranged to compare the signal strength of the received command signal to a plurality of different predetermined threshold values, each indicative of different distance from the receiver, and the controller is arranged to perform a different function for each distance threshold.

7. The system of claim 1 further comprising a signal processor connected to the receiver for determining whether the received command signal is one of a set of commands enabled only for short-range operation, wherein the controller is responsive to the signal processor for performing the function associated with a short-range enabled command signal if the transmitter is detected as being within the predetermined range.

8. The system of claim 1 wherein the transmitter comprises an FM transmitter, the transmitter arranged to transmit the command signal with a narrower FM deviation if the command signal is to trigger operation of the first function, and a wider FM deviation if the command signal is to trigger operation of the other function.

9. The system of claim 1 wherein the transmitter comprises an ASK transmitter, the transmitter arranged to transmit the command signal with a narrower bit width if the command signal is to trigger operation of the first function, and a wider bit width if the command signal is to trigger operation of the other function.

10. A method of remotely controlling operation of at least two different functions in a wireless remote control system, wherein the system includes a transmitter and a receiver, the method comprising:
transmitting a command signal;
receiving the command signal;
detecting the distance of the transmitter from the receiver as a function of the signal strength of the received signal; and
per forming a first function if the transmitter is detected as being within a predetermined range, and a different function if the transmitter is detected as being outside the predetermined range.

11. The method of claim 10 wherein receiving the command signal further comprises generating an output signal that is proportional to the signal strength of the received command signal.

12. The method of claim 10 wherein detecting the distance comprises comparing the signal strength of the received command signal to a predetermined threshold value indicative of distance from the receiver.

13. The method of claim 12 further comprising comparing the signal strength of the received command signal to a plurality of different predetermined threshold values, each indicative of different distance from the receiver, and performing a different function for each distance threshold.

14. The method of claim 10 further comprising determining whether the received command signal is one of a set of commands enabled only for short-range operation, and performing the function associated with a short-range enabled command signal if the transmitter is detected as being within the predetermined range.

15. The method of claim 10 further comprising altering a parameter of a command signal to reduce signal strength if the command signal is only enabled for a shorter range.
